(19) United States
(12) Patent Application Publication
(10) Pub. No.: US 2024/0280718 A1
(43) Pub. Date: Aug. 22, 2024

(54) TTCE DENSE ACOUSTIC ARRAY SLIM TOOL

(71) Applicant: Halliburton Energy Services, Inc., Houston, TX (US)

(72) Inventors: Chung CHANG, Houston, TX (US); Jing JIN, Singapore (SG); Gary Wayne KAINER, Tomball, TX (US); Ruijia WANG, Singapore (SG); Xiang WU, Singapore (SG); Keith BELLMAN, Houston, TX (US)

(73) Assignee: Halliburton Energy Services, Inc., Houston, TX (US)

(21) Appl. No.: 18/292,478

(22) PCT Filed: May 11, 2022
(86) PCT No.: PCT/US2022/028816

§ 371 Date: Jan. 26, 2024

Related U.S. Application Data
(60) Provisional application No. 63/272,825, filed on Oct. 28, 2021.

(51) Int. Cl. G01V 1/52; E21B 47/005

(52) U.S. Cl. CPC G01V 1/523; E21B 47/005

(57) ABSTRACT

Aspects of the subject technology relate to systems and methods for providing a TTCE dense acoustic array slim tool. An example through tubing cement evaluation (TTCE) tool comprising: a housing including a longitudinal axis; a transmitter being positioned within the housing, the transmitter being configured to operate in sonic and ultrasonic frequencies and being angled with respect to the longitudinal axis; a plurality of receivers being positioned within the housing, each of the plurality of receivers being isolated from the transmitter; one or more processors; and at least one computer-readable storage medium having stored therein instructions which, when executed by the one or more processors, cause the TTCE tool to: receive at least one of sonic and ultrasonic data from the plurality of receivers; and determine tubing or cement angular information based on the at least one of the sonic and ultrasonic data received from the plurality of receivers.

### CROSS-REFERENCE TO RELATED APPLICATIONS

This application claims the benefit of U.S. Provisional Application No. 63/272,825, filed Oct. 28, 2021, for TTCE DENSE ACOUSTIC ARRAY SLIM TOOL, which is incorporated herein by reference.

### TECHNICAL FIELD

The present technology pertains to optimizing evaluation tools, and more particularly, to optimizing through tubing cement evaluation tools.

### BACKGROUND

Through tubing cement evaluation (TTCE) tools typically go through tubing with restricted zones. For example, the tool's outside diameter may be limited to 2.25 inches, which means that transmitters and receivers have to be of a smaller size. Moreover, the tubing is usually not well centralized within the cemented casing. One needs to have acoustic measurements that can indicate tubing position accurately as well as acoustic measurements that are sensitive to cement conditions outside of the casing. However, cement defects may be positioned at certain azimuthal directions and depths.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a diagrammatic view of an exemplary logging while drilling (LWD) and/or measurement while drilling (MWD) borehole operating environment in which the present disclosure can be implemented, in accordance with aspects of the present disclosure.

FIG. 2 illustrates a diagrammatic view of a conveyance logging borehole operating environment, in accordance with aspects of the present disclosure.

FIG. 3 illustrates a diagrammatic view of a borehole operating environment model which may be used by the methods of the present disclosure, in accordance with aspects of the present disclosure.

FIG. 4 illustrates a cross-sectional view of an example dense array acoustic tool, in accordance with aspects of the present disclosure.

FIG. 5 illustrates a perspective view of an example dense array acoustic tool, in accordance with aspects of the present disclosure.

FIG. 6 illustrates an example graph of receiver frequency responses, in accordance with aspects of the present disclosure.

FIG. 7 illustrates an example graph of a transmitter frequency response calibration test in a water tank, in accordance with aspects of the present disclosure.

FIGS. 8A and 8B illustrate example isolators, in accordance with aspects of the present disclosure.

FIG. 9 illustrates an example pulse reception pattern of an imbedded hydrophone on a steel mass block, in accordance with aspects of the present disclosure.

FIG. 10 illustrates a transparent view of an example angled transmitter, in accordance with aspects of the present disclosure.

FIG. 11 illustrates a cross-sectional view of an example angled transmitter, in accordance with aspects of the present disclosure.

FIG. 12 illustrates an exploded view of an example transmitter assembly, in accordance with aspects of the present disclosure.

FIG. 13 illustrates a perspective view of an example wrap around an acoustic reflector, in accordance with aspects of the present disclosure.

FIG. 14 illustrates a cross-sectional view of an example wrap around an acoustic reflector, in accordance with aspects of the present disclosure.

FIGS. 15A and 15B illustrate example graphs of an angled transmitter test results in a monopole form, in accordance with aspects of the present disclosure.

FIG. 16 illustrates example acoustic radiation simulations in a vertical plane and a horizontal plane, in accordance with aspects of the present disclosure.

FIG. 17 illustrates example graphs of measurements of 360 degrees Casing reflections from inside an eccentered tubing, in accordance with aspects of the present disclosure.

FIG. 18 shows an example process for providing a TTCE dense acoustic array slim tool, in accordance with aspects of the present disclosure.

FIG. 19 illustrates an example computing device architecture that can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In various embodiments, a through tubing cement evaluation (TTCE) tool is provided and comprises: a housing including a longitudinal axis; a transmitter being positioned within the housing, the transmitter being configured to operate in sonic and ultrasonic frequencies and being angled within a range of about 15 to about 45 degrees From the longitudinal axis; a plurality of receivers being positioned within the housing, each of the plurality of receivers being isolated from the transmitter; one or more processors; and at least one computer-readable storage medium having stored therein instructions which, when executed by the one or more processors, cause the TTCE tool to: receive sonic and ultrasonic data from the plurality of receivers; and determine tubing or cement angular information based on the sonic and ultrasonic data received from the plurality of receivers.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

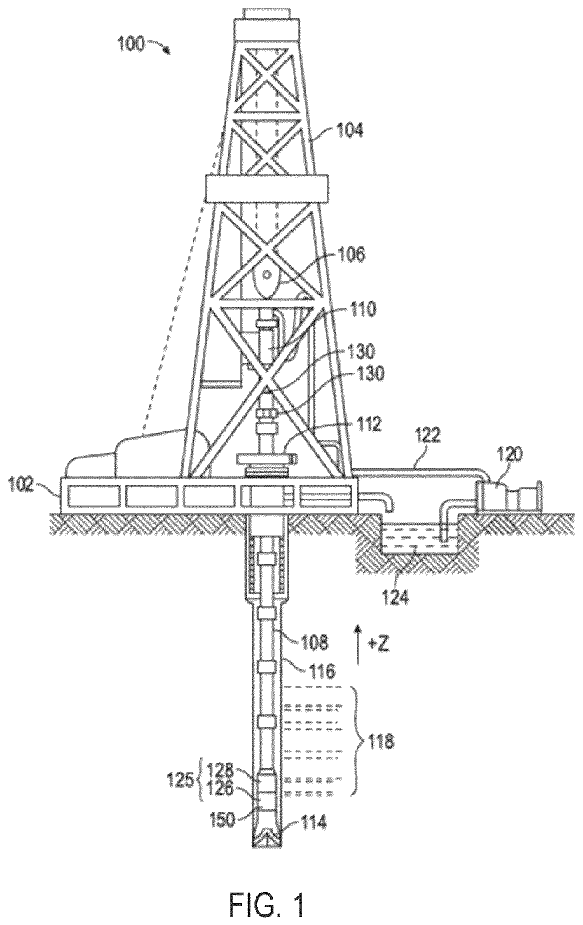

FIG. 1 illustrates a diagrammatic view of an exemplary logging while drilling (LWD) and/or measurement while drilling (MWD) borehole operating environment 100 in which the present disclosure can be implemented. A drilling platform 102 is equipped with a derrick 104 that supports a hoist 106 for raising and lowering a drill string 108. The hoist 106 suspends a top drive 110 suitable for rotating the drill string 108 and lowering the drilling string 108 through the well 112. Connected to the lower end of the drill string 108 is a drill bit 114 which creates a borehole 116 by rotating and passing through various geological formations 118. A pump 120 circulates drilling fluid through a supply pipe 122 to top drive 110, down through the interior of drill string 108, through orifices in drill bit 114, back to the surface via the annulus around drill string 108, and into a retention pit 124. The drilling fluid transports cuttings from the borehole 116 into the pit 124 and aids in maintaining the integrity of the borehole 116. Various materials can be used for drilling fluid, including oil-based fluids and water-based fluids.

Logging tools 126 can be integrated into a bottom-hole assembly 125 near the drill bit 114. As the drill bit 114 extends the borehole 116 through the formations 118, logging tools 126 collect measurements relating to various formation properties as well as tool and/or other drilling conditions. The bottom-hole assembly 125 can also include a telemetry sub 128 to transfer measurement data to a surface receiver 130 and to receive commands from the surface. In some embodiments, the telemetry sub 128 does not communicate with the surface, but rather stores logging data for later retrieval at the surface when the logging assembly is recovered.

Each of the logging tools 126 can include multiple tool components, spaced apart from each other, and communicatively coupled with one or more wires. Logging tools 126 can include, for example, sonic receivers and/or emitters for performing acoustic measurements of the borehole 116. The telemetry sub 128 can include wireless telemetry or logging capabilities, or both, such as to transmit or later provide information indicative of received acoustic energy/waveforms (e.g., pressure waves, etc.) to operators on the surface or for later access and data processing for the evaluation of formation 118 properties.

The logging tools 126, including the acoustic logging tool, may also include one or more computing devices 150 communicatively coupled with one or more of the plurality of tool components. The computing device 150 may be configured to control or monitor the performance of the tools 126, process logging data, and/or carry out the methods of the present disclosure.

In some embodiments, one or more of the logging tools 126 may communicate with a surface receiver 130, such as wired drillpipe. In other cases, the one or more of the logging tools 126 can communicate with a surface receiver 130 by wireless signal transmission. In at least some cases, one or more of the logging tools 126 may receive electrical power from a wire that extends to the surface, including wires extending through a wired drillpipe. In at least some instances the methods and techniques of the present disclosure may be performed by a computing device (not shown) located on the surface. In some embodiments, the computing device may be included in the surface receiver 130. For example, surface receiver 130 of the wellbore operating environment 100 at the surface may include one or more of wireless telemetry, processor circuitry, or memory facilities, such as to support substantially real-time processing of data received from one or more of the logging tools 126. In some embodiments, data is processed at some time subsequent to its collection, wherein the data may be stored on the surface at surface receiver 130, stored downhole in telemetry sub 128 or both, until it is retrieved for processing.

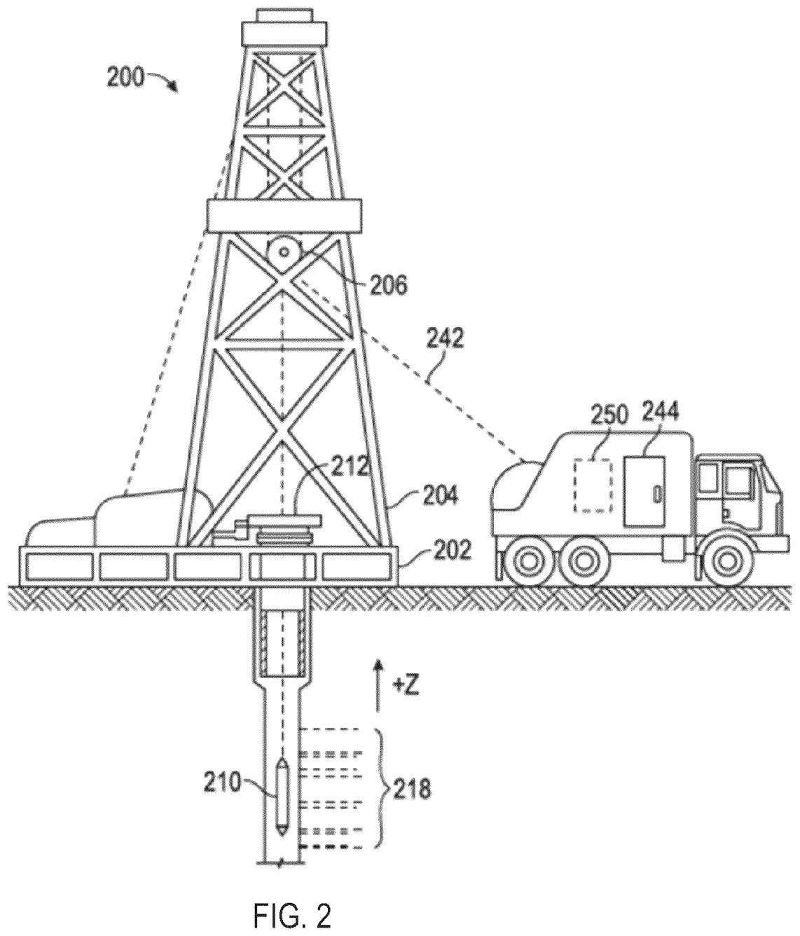

FIG. 2 illustrates a diagrammatic view of a conveyance logging (WL) borehole operating environment 200 (also referred to as “wireline” in the field) in which the present disclosure can be implemented. A hoist 206 can be included as a portion of a platform 202 which is coupled to a derrick 204. The hoist 206 may be used to raise or lower equipment such as acoustic logging tool 210 into or out of a borehole. Acoustic logging tool 210 can include, for example, sonic receivers and/or emitters for performing acoustic measurements of the borehole. A conveyance 242 provides a communicative coupling between the acoustic logging tool 210 and a logging facility 244 at the surface. The conveyance 242 may include wires (one or more wires), slicklines, cables, or the like, as well as tubular conveyances such as coiled tubing, joint tubing, or other tubulars, and may include a downhole tractor. Additionally, power can be supplied via the conveyance 242 to meet power requirements of the tool. The acoustic logging tool 210 may have a local power supply, such as batteries, downhole generator and the like. When employing non-conductive cable, coiled tubing, pipe string, or downhole tractor, communication may be supported using, for example, wireless protocols (e.g. EM, acoustic, etc.), and/or measurements and logging data may be stored in local memory for subsequent retrieval. The logging facility 244 may include a computing device 250 able to carry out the methods and techniques of the present disclosure. Data regarding a formation 218 can be obtained by acoustic logging tool 210 and processed by computing device 250. In some embodiments, computing device 250 may be equipped to process received information in substantially real-time. In some embodiments, computing device 250 may store the received information for later retrieval and processing, either on-site or elsewhere.

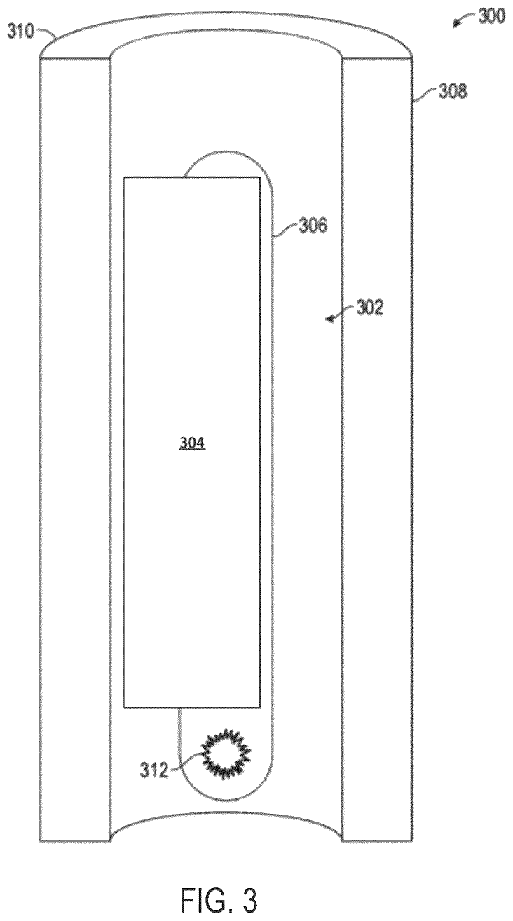

FIG. 3 illustrates a diagrammatic view of a borehole operating environment model 300 which may be used by the methods of the present disclosure. The borehole operating environment model 300 includes a fluid-filled borehole 302 which extends down from a surface 310 and may be filled with mud, drilling fluid, and other fluid materials. A sonic logging tool 306 is included within the fluid-filled borehole 302 and can be a WL sonic logging tool or an LWD sonic logging tool. A formation 308 is further included in the borehole operating environment model 300 and surrounds the fluid-filled borehole 302.

The sonic logging tool 306 can measure refracted and guided waves propagating along sidewalls of the fluid-filled borehole 302. Acoustic properties of the formation 308 can then be extracted (e.g., derived) from the measured waves. More particularly, the sonic logging tool 306 includes an acoustic emitter 312 which can excite acoustic waves for one or more receivers 304 along the sonic logging tool 306. Further, data regarding the fluid-filled borehole 302 and surrounding formation 308 can be determined by various characteristics of a wave propagation detected by the one or more receivers 304, e.g. receiving the wave in sequence. For example, a time delay between a plurality of receivers or a single moving receiver may be used to determine various characteristics of the medium through which the wave propagated (e.g., the fluid-filled borehole 302 or formation 308).

The sonic logging tool can excite and capture borehole guided waves such as, for example and without imputing limitation, flexural waves for WL logging, screw waves for LWD logging, and leaky-P waves for a soft formation. The captured borehole guided waves can then be used to measure acoustic properties of the formation 308, such as formation body compressional slowness and body shear wave slowness.

As provided above, through tubing cement evaluation (TTCE) tools typically go through tubing with restricted zones. For example, the tool's outside diameter may be limited to 2.25 inches, which means that transmitters and receivers have to be of a smaller size. Moreover, the tubing is usually not well centralized within the cemented casing. One needs to have acoustic measurements that can indicate tubing position accurately as well as acoustic measurements that are sensitive to cement conditions outside of the casing. However, cement defects may be positioned at certain azimuthal directions and depths.

As such, a need exists for a TTCE tool that can measure and detect an azimuthal cement defect with depths. The present disclosure includes systems and methods that can provide high frequency acoustic measurements, which can pinpoint a tool and tubing positions along with lower frequency acoustic measurements to penetrate tubing and casing that interact with cement behind a casing. Moreover, the high frequency measurement results can be utilized in a lower frequency measurement processing workflow to further interpret and correct cement maps. The TTCE tool can also combine both measurements to simplify tool configuration into a single inline physical array. The TTCE tool can also include a single transmitter that is short and lightweight for a motor to rotate the TTCE tool, thereby providing azimuthal cement conditions.

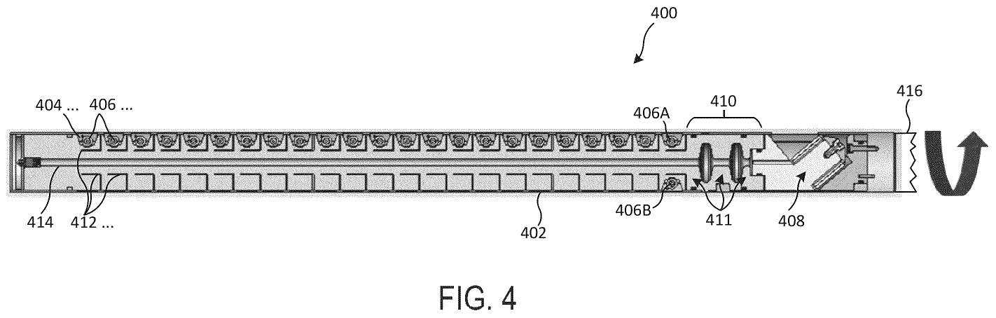

FIG. 4 illustrates a cross-sectional view of an exemplary dense array acoustic tool in accordance with aspects of the present disclosure. In some implementations, the dense array acoustic tool can be embodied as a through tubing cement evaluation (TTCE) tool 400. The TTCE tool 400 can include a tool structure 402 (e.g., a 3D-printed tool structure) that can house a plurality (e.g., twenty-three) of unipolar, broad-bandwidth (e.g., about 1 kHz to over 100 kHz) unipolar receivers 406, collectively referred to as a “receiver array.” In some embodiments, there may be a one-inch spacing between each of the receivers 406. In other implementations, more or fewer unipolar receivers 406 and/or different spacings can be utilized by the TTCE tool 400 as described herein and understood by a person of ordinary skill in the art.

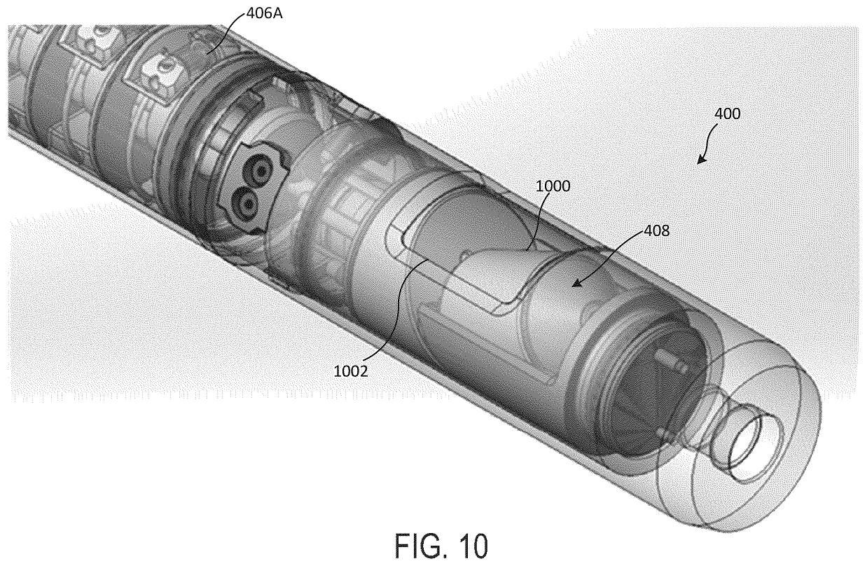

The TTCE tool 400 can also include an angled (or tilted) unipolar transmitter 408 having a bandwidth, for example, between about 1 kHz and 150 kHz. The angled transmitter 408 will be described in greater detail in conjunction with FIGS. 10-14.

The 3D printed tool structure 402 can be configured to provide acoustic isolation between the transmitter 408 and the first receiver 406A to effectively reject direct TTCE tool waves. For example, along the length of the TTCE tool 400, the 3D printed tool structure 402 can provide an acoustic isolation mechanism 410 to prevent secondary tool waves that are introduced by the transmitter 408 as excited borehole waves. The acoustic isolation mechanism 410 can include gaps or cavities 411 that may be substantially perpendicular to the TTCE tool 400 axis to reflect direct tool waves generated by the angled transmitter 408.

In some implementations, the TTCE tool 400 can include receiver mass blocks 404 that support the receivers 406. The receiver mass blocks 404 can include cylindrical gaps that limit contact between each mass block and its central supporting rod to stop tool wave propagation across each mass block and to contain tool waves within each receiver mass block 404 if tool waves are introduced by borehole propagating waves. Due to the limited contact area of the tool waves traveling along the supporting rod 414 (also referred to herein as a “load bearing shaft”), the TTCE tool 400 can release small amounts of acoustic energy across the junction, which can barely reach the receivers 406 mounted on the TTCE tool 400.

Without shrinking the load bearing shaft 414, the tool structure 402 of the TTCE tool 400 can also include a set of acoustic isolators 412 to block direct tool waves and borehole waves introduced by secondary tool waves that travel along the receiver structure. In some embodiments, the acoustic isolators 412 may have an L-shaped cross-section, as illustrated in FIG. 4, which introduces gaps and cavities in order to isolate the receivers 406.

To prevent spatial aliasing and to catch casing reflections from changing target distances, the TTCE tool 400 can include, as noted above, a receiver array with each of the receivers 406 being spaced apart by a particular distance (e.g., approximately one-inch). In such examples, the TTCE tool 400 may not miss reflected signal events by the outer casing, especially when tubing is highly eccentered. With a short receiver distance, the receivers 406 of the TTCE tool 400 may be smaller or include a special orientation to allow for the one-inch distance, without compromising sensitivity.

In some examples, three types of measurements can be determined by TTCE tool 400. First, the TTCE tool 400 can measure ultrasonic pitch-catch measurements by utilizing the angled transmitter 408 and unipolar receivers 406 positioned near (proximal to) the transmitter 408. Second, the TTCE tool 400 can measure sonic pitch-catch measurements using receivers 406 that may be positioned further away (distal) from the transmitter. Third, the TTCE tool 400 can include additional receivers (e.g., 406B) that are positioned opposite to the first receiver 406 to facilitate dipole and monopole resonant mode measurements (receivers 406A-B form a dipole). With the one-inch receiver spacing, which could not be achieved previously, the TTCE tool 400 can be short and light to measure borehole acoustic signals without being disturbed by spatial aliasing that may be introduced by high operating frequencies.

In some embodiment, the short and light array TTCE tool 400 can rotate by a motor 416 to provide azimuthal acoustic measurements. The motor 416 can also be at the opposite end of tool 400. In other embodiments (not shown), the motor 416 may rotate only the angled transmitter 408 or only the receiver array. In such embodiments, a ring of receivers 406 may be positioned radially around the supporting rod 414 in order to make azimuthal acoustic measurements. For example, a ring of four, six, eight, or more receivers 406 may be used in some embodiments.

In certain implementations, the TTCE tool 400 can be a 2.25-inch outer diameter (OD) acoustic tool that can combine both pitch-catch ultrasonic and sonic pitch-catch measurements. The TTCE tool 400 can enable multiple independent cement defect detection answers and their physical agreements, which can further improve cement map accuracy and reliability.

As described herein, the TTCE tool 400 can evaluate cement quality behind an outside casing, which can generate significant financial incentives that reduce time and risk of plugging and abandoning an aged well for oil companies. Most aged wells have tool deployment restrictions along the well. The TTCE tool 400 addresses this limitation by providing a slim acoustic tool that can evaluate cement conditions regardless of tubing and casing sizes.

If there is a 2.25 inch tool OD requirement, it is not a simple engineering task to shrink down current acoustic tool sizes in proportion to the OD requirement. Such challenges include: shrinking a receiver and transmitter will lose its sensitivity and/or acoustic radiating output, as well as shifting its operating bandwidth to a higher frequency; the mechanical pulling strength required by the operation will remain static; acoustic isolators may not function due to new tool dimensions; there is no capacity to include an azimuthal receiver array; combining ultrasonic and sonic tool functions into a single sonde as well as using a single transmitter has never been achieved before, etc.

The systems and methods described herein can determine acoustic measurements that are sensitive enough to evaluate cement behind a casing. For example, in some implementations, the systems and methods can utilize casing S0 and A0 propagating modes; third interface echoes including both low and high frequencies; and pulse-echo borehole resonance modes. The third interface echo can be performed by an ultrasonic pitch-catch measurement. The S0 and A0 can also be measured by a sonic tool. Furthermore, the TTCE tool 400 can include an azimuthal measurement capability.

In some implementations, the TTCE tool 400 can satisfy pulling strength and azimuthal measurement requirements by rotating the array acoustic tool without compromising the TTCE tool 400's mechanical strength and receiver quality, as well as its sensitivity. For example, while rotating, the TTCE tool 400 can sample every 10 degrees to obtain a perfectly match thirty-six azimuthal receiver responses.

In other implementations, the TTCE tool 400 can include unipolar transmitters that can

perform ultrasonic pitch-catch measurements as well as sonic pitch-catch measurements. The unipolar receivers 406 can utilize a bandwidth that covers both ultrasonic and sonic frequency ranges.

In some examples, the TTCE tool 400 can include: a unipolar transmitter that covers both ultrasonic and sonic measurements; a linear unipolar receiver array with built-in acoustic isolations and bandwidth, as well as sensitivity for both ultrasonic and sonic measurements; isolators positioned between the unipolar transmitter and the first receiver, which can be utilized for both ultrasonic and sonic frequencies; and a motor to rotate the array of the TTCE tool 400.

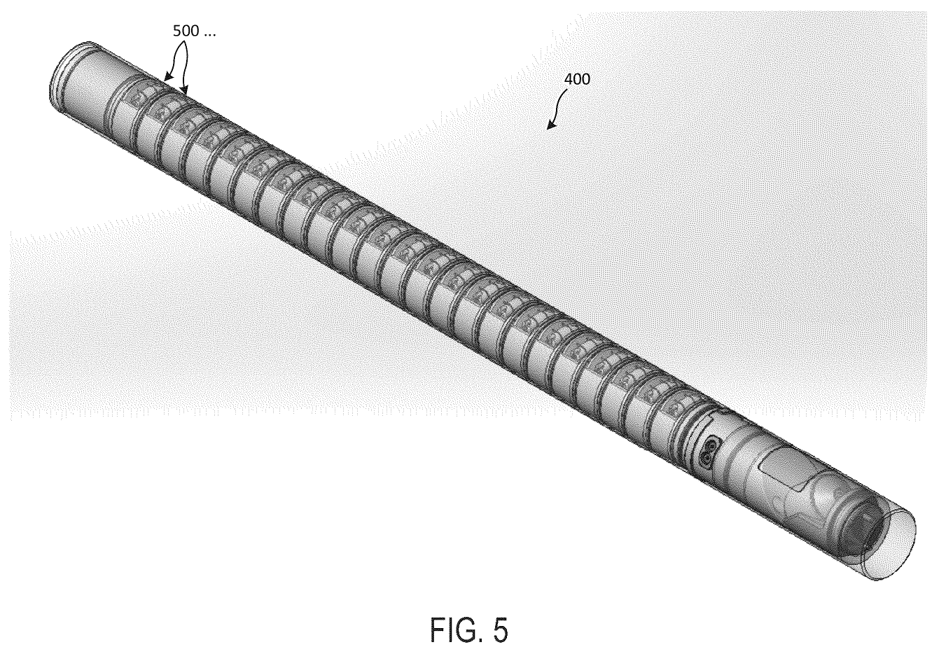

FIG. 5 illustrates a perspective view of an example dense array acoustic tool (e.g., TTCE tool 400), in accordance with aspects of the present disclosure. In some implementations, the receivers of the dense array acoustic tool can be embodied as cylindrical-shaped hydrophones 500 (e.g., receivers 406) that may be oriented to allow placement with a one-inch spacing, without compromising sensitivity of the dense array acoustic tool. The hydrophones 500 can utilize a bandwidth from a few tenths of Hz to 100 kHz or a bandwidth from 100 Hz to 170 KHz. The hydrophone can also determine ultrasonic and sonic measurements without using a separated receiver.

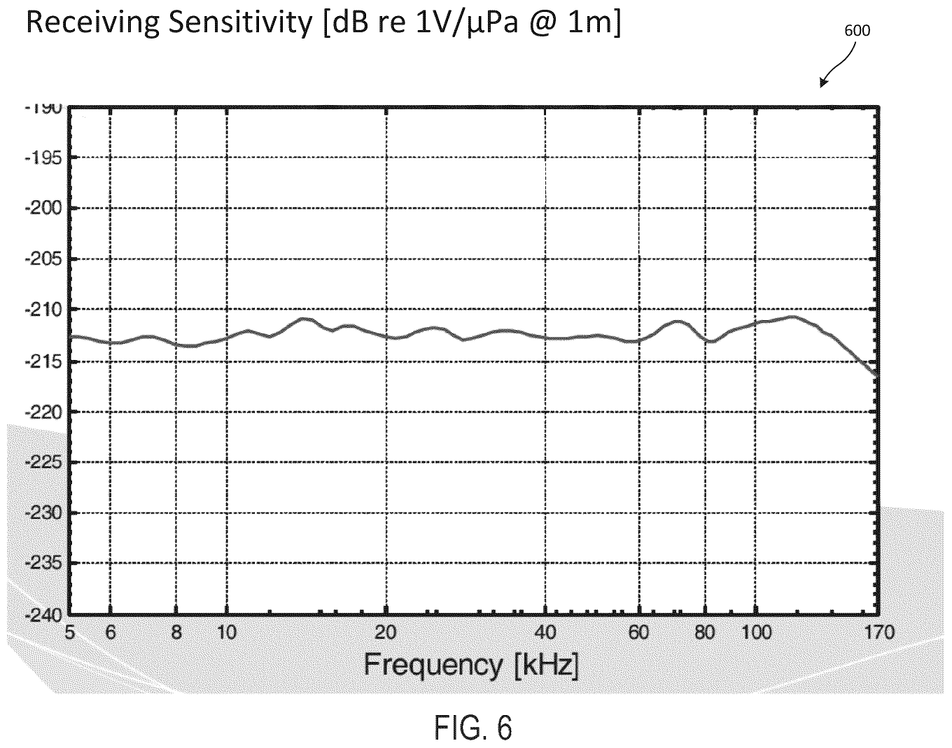

FIG. 6 illustrates an example graph 600 of receiver frequency responses, in accordance with aspects of the present disclosure. In some examples, FIG. 6 illustrates a graph of frequency responses with a receiving sensitivity of dB re 1V/μPa @ 1m. In some implementations, FIG. 6 illustrates frequency responses of a hydrophone 500 (shown in FIG. 5), which demonstrates that the TTCE tool 400, as described herein, can provide a bandwidth that covers both ultrasonic and sonic measurements. For example, FIG. 6 illustrates an example bandwidth calibration in a free field water tank measurement.

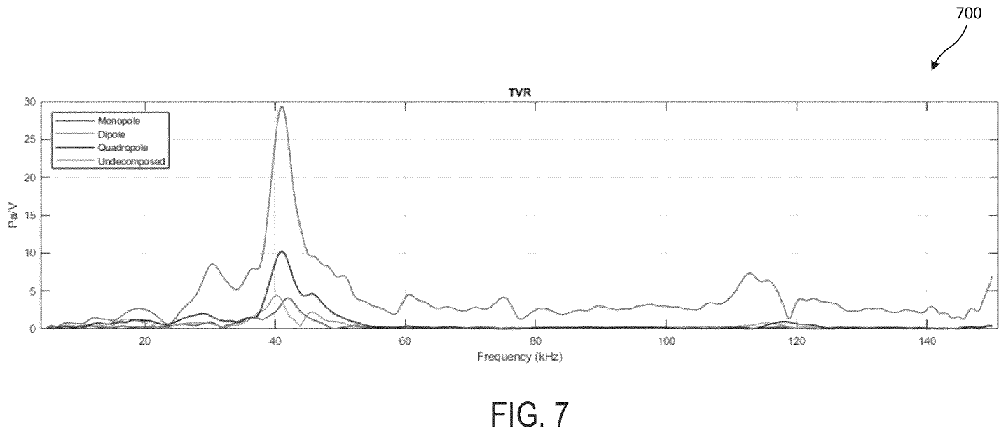

FIG. 7 illustrates an example graph 700 of a transmitter calibration test in a water tank, in accordance with aspects of the present disclosure. In some implementations, the transmitter calibration test can include obtaining free field transmitter calibration measurements inside a large water tank using a calibrated commercial hydrophone at one meter. FIG. 7 illustrates multiple spectrum curves including a monopole curve, a dipole curve, a quadropole curve, and an undecomposed curve. The undecomposed curve includes the largest amplitude response and can be a raw transmitter response, while the other amplitude curves (e.g., the monopole curve, the dipole curve, and the quadropole curve) can be processed results for a modal purity study, which can be ignored. In some examples, the TTCE tool 400 can include an effective bandwidth from approximately 1 kHz to 150 kHz.

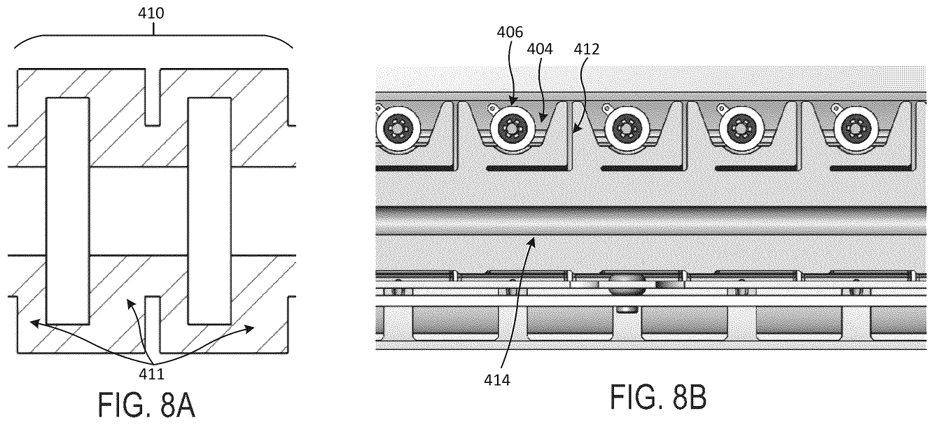

FIGS. 8A and 8B illustrate example isolators (410 and 412, respectively), in accordance with aspects of the present disclosure. FIG. 8A illustrates the isolation mechanism 410 between the angled transmitter 408 and the first receiver 406A (shown in FIG. 4), while FIG. 8B illustrates the L-shaped isolators 412 associated with each receiver 406 and mass block 404. In some examples, circular disks or ring shapes of material gaps can be utilized with an alternating sequence of an external and an internal one to reflect direct tool waves traveling along the longitudinal axis of the TTCE tool 400 (e.g., horizontal axis of FIG. 8B). As the distance between the transmitter 408 and the first receiver 406A may be short, the TTCE tool 400 can utilize isolators 410/412 to reduce the amplitude of direct tool waves. As the transmitter 408 of the TTCE tool 400 may utilize a wide operating frequency band, the isolators 410/412 may also function for wide bandwidth tool waves.

In other implementations, borehole waves can be excited by the transmitter 408 and can also continue generating secondary tool waves due to their coupling to the body of the TTCE tool 400. Referring to FIGS. 4, 5, 8A, and 8B, each hydrophone 500 (e.g., receiver 406) can be positioned in a pocket of ring mass, which can be physically coupled to the center shaft 414 and the material gaps of the TTCE tool 400 that may be introduced between the ring masses, as well as between ring masses and the center shaft 414 of the TTCE tool 400. The material gaps can prevent coherent excitations of tool waves due to borehole propagating waves and isolate tool waves traveling along the load bearing shaft 414 of the TTCE tool 400. A limited amount of tool wave energy can leak into the receiver mass block 404, but may not reach the hydrophone 500 that may be mounted in the pocket (formed by the L-shaped isolators 412) outside of the receiver mass block 404 of the TTCE tool 400. In some examples, the receiver structure of the TTCE tool 400 can be 3D printed to address some of the geometries and small gaps as described in the present disclosure.

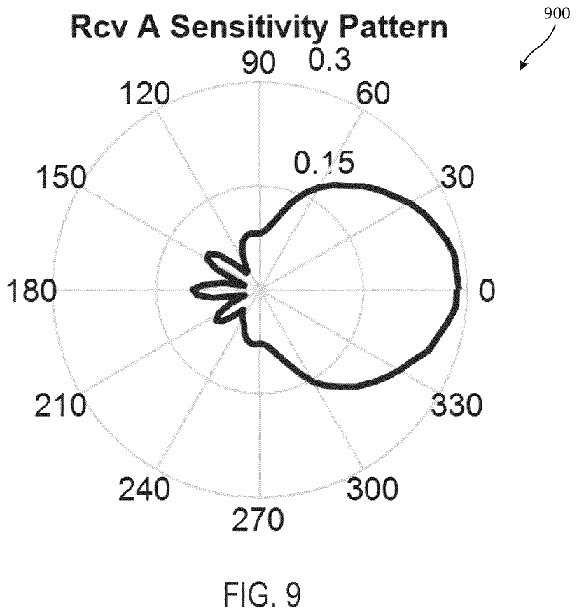

FIG. 9 illustrates an example pulse reception pattern 900 of an imbedded hydrophone 500 (shown in FIG. 5) on a steel mass block 404 (shown in FIGS. 4 and 8B), in accordance with aspects of the present disclosure. In some implementations, FIG. 9 illustrates a hydrophone reception response for a hydrophone 500 positioned inside of a pocket of a receiver mass block of a TTCE tool 400 (shown in FIG. 4). In some examples, the TTCE tool 400 can include an acoustic shielding of the steel mass block 404 behind the hydrophone 500. The omni-directional hydrophone 500 can also be positioned inside of a pocket of steel mass block 404, thereby being a unipolar receiver. The unipolar reception behavior will increase with increasing frequency. The acoustic physics of the receiver of the TTCE tool 400 can assist in receiving ultrasonic pitch-catch measurements as well as improving the azimuthal resolution of sonic measurements.

In other implementations, when the TTCE tool 400 is positioned inside of a tubing with an outside casing, the TTCE tool 400 can receive signals from both the tubing and the outside casing. The identified signals can represent casing cement conditions. For example, casing S0 and A0 modes can be utilized; third interface echoes including both low and high frequencies; and pulse-echo borehole resonance modes. Furthermore, the third interface echo from 360-degree measurements can be used to pinpoint tubing position inside of a casing.

As described above, the TTCE tool 400 can obtain various measurements. First, the TTCE tool 400 can obtain ultrasonic pitch-catch measurements by utilizing the angled transmitter 408 (shown in FIG. 4) and receivers 406 near the transmitter 408 to acquire reflected events due to the outside casing, where the signals can be mixed with tubing echoes. The TTCE tool 400 can utilize several processing techniques to separate casing and tubing echoes. In some implementations, the ultrasonic pitch-catch technology (e.g., the TTCE tool 400) can utilize non-piston type transmitters and receivers in the TTCE tool 400.

Second, longer transmitter-receiver sonic pitch-catch measurements can be provided by the transmitter 408 at a lower frequency, while the receivers 406 can be positioned further away from the transmitter 408 to record/receive the signals.

Third, the TTCE tool 400 can utilize various borehole resonant modes to obtain measurements, thereby accomplishing both monopole and dipole resonant mode measurements using near receivers as well as a first dipole pair receiver. In some examples, the TTCE tool 400 can be a rotating tool. In other examples, the azimuthal sampling angle can be predetermined. For example, the azimuthal sampling angle can be every ten to fifteen degrees and may depend on the operating frequency and azimuthal resolution.

Referring to FIG. 10 (with continuing reference to FIG. 4), a transparent perspective view of the TTCE tool 400 with an angled transmitter 408 is illustrated. Traditionally, a tilted piston-type ultrasonic transmitter tool configured in a pitch-catch configuration for detecting a third interface echo will have problems of going through well restrictions in additional to its large size. Moreover, traditional transmitter tools have issues with inline, angled transmitters and obtaining sonic and ultrasonic measurements.

In the present disclosure, a cylindrical monopole packaging technology is described. For example, in some implementations, a TTCE tool 400 can include a tilted lead zirconate titanate (PZT) cylinder 1000, without changing a tool profile, for an inline implementation of a TTCE transmitter 408. In some examples, the TTCE tool 400 can utilize a bandwidth that covers a frequency range from approximately 1 kHz to 150 kHz. As such, the TTCE tool 400 can utilize both sonic and ultrasonic frequency bands.

The TTCE tool 400 can include a front opening 1002 with a non-uniform thickness metal backing that can enable collimated acoustic beam radiation. In some examples, the beam quality increases as the operating frequency increases. The transmitter 408 of the TTCE tool 400 can also be modular, allowing it to be replaced once a different tilted angle is determined.

In some implementations, with a reduced transmitter size and power, the TTCE tool 400 can be configured to have a first receiver 406A be closer to the transmitter 408 to have enough signal strength for a better signal-to-noise quality. In some examples, the TTCE tool 400 can also detect 360 degrees of cement conditions by implementing a unipolar transmitter and receiver along a slim acoustic tool body and by using a motor 416 (shown in FIG. 4), allowing the TTCE tool 400 to receive data at several specified angular sampling positions.

In some implementations, the TTCE tool 400 can convert an extended frequency sonic monopole into a suitable ultrasonic pitch-catch measurement transmitter with a collimated acoustic beam radiation. For example, FIG. 10 illustrates a TTCE tool 400 with an inline angled transmitter 408 at one end of the TTCE tool 400. The TTCE tool 400 as described herein can include a PZT cylinder 1000 that can fit inside an OD profile of the 2.25-inch OD tool, which allows the TTCE tool 400 to go through most well restrictions. Without considering the low frequency sonic measurement we can implement a traditional disk type of ultrasonic transducer placed with a tilted angle as well.

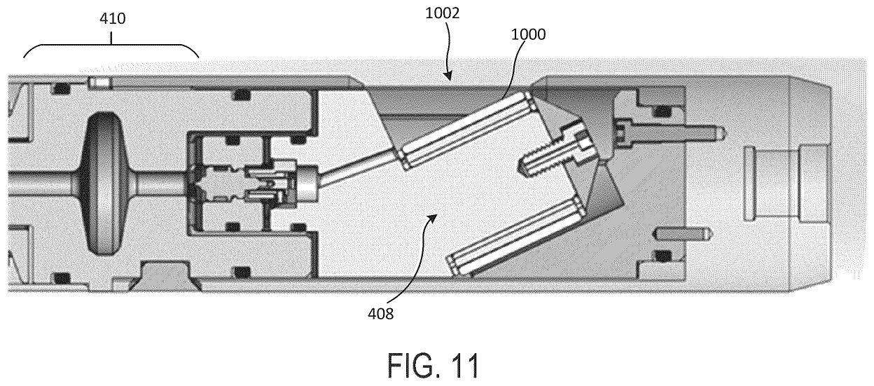

FIG. 11 illustrates a cross-sectional view of an example angled transmitter 408, in accordance with aspects of the present disclosure. In some implementations, The TTCE tool 400 can include a cylindrical transmitter 408 that may be tilted within a range of about 15 to 45 degrees (e.g., at approximately 40 degrees) from the axis of the TTCE tool 400 (e.g., a longitudinal axis of the TTCE tool 400). FIG. 11 further illustrates the PZT cylinder 1000, as well as the front opening 1002.

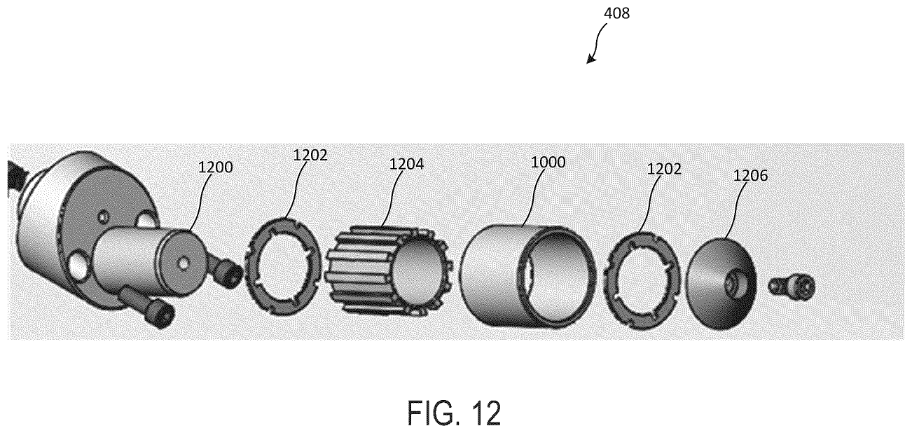

FIG. 12 illustrates an exploded view of an example transmitter assembly, in accordance with aspects of the present disclosure. In some implementations, the TTCE tool 400 can include a cylindrical monopole transmitter 408 that can generate a wide operating bandwidth. In some examples, the monopole transmitter 408 can include: a solid cylindrical shaft 1200; an insulation washer 1202; a rubber dampener 1204; a PZT cylinder 1000; an insulation washer 1202; and an end cap 1206.

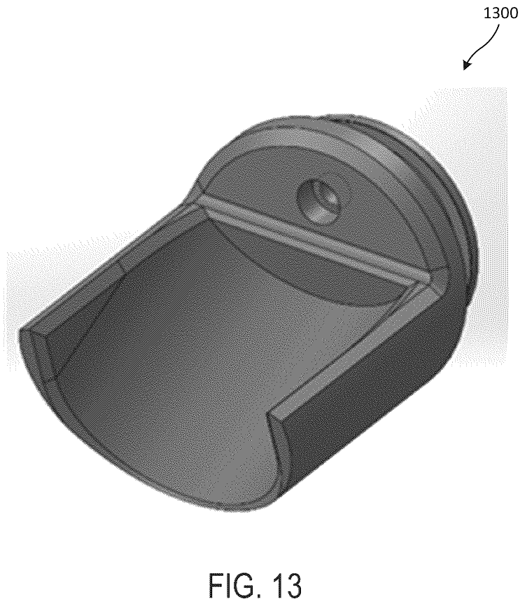

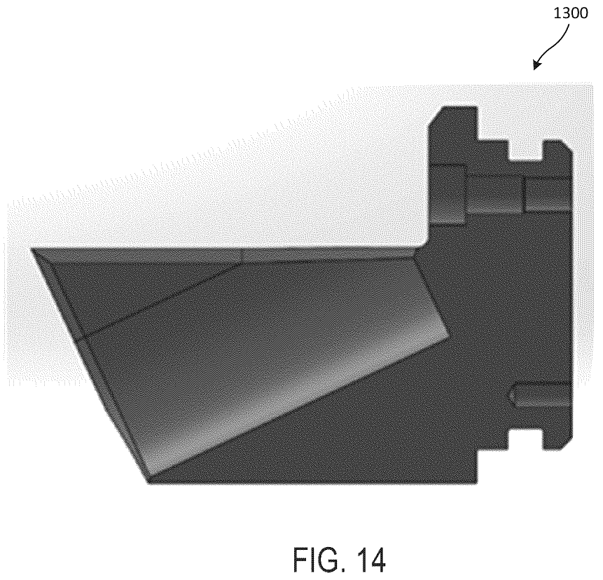

FIG. 13 illustrates a perspective view of an example acoustic reflector 1300, in accordance with aspects of the present disclosure, which wraps around the PZT cylinder 1000 (shown in FIG. 10) in some embodiments. FIG. 14 illustrates a cross-sectional view of the acoustic reflector 1300, in accordance with aspects of the present disclosure.

In some embodiments, the acoustic reflector 1300 converts a monopole transmitter into a directional transmitter at higher frequencies. The acoustic reflector 1300 may be wedge-shaped (i.e., have a wedge-shaped cross-section) and comprise a non-uniform thickness solid metal that can wrap around the PZT cylinder 1000.

As previously discussed, the TTCE tool 400 can include a 90-degree acoustic window 1002 (shown in FIGS. 10 and 11) that may be opened in a predetermined acoustic radiating direction. In addition, the acoustic reflector 1300 can include a high acoustic impedance contrast that can cover the monopole transmitter to transform the monopole transmitter into a direction transmitter. As shown in FIGS. 11 and 12, the transmitter 408 can be bolted to the receiver array at its left side. As such, this modular assembly separation can allow the replacement of the angled transmitter 408 if the tilted angle of the transmitter 408 is to be changed. The angled transmitter 408 can be modular, not only to provide different transmitter tilt angle selections, but also to allow the insertion of a section of spacers or acoustic isolators that can provide additional flexibility when adjusting the tool transmitter to the first receiver spacing.

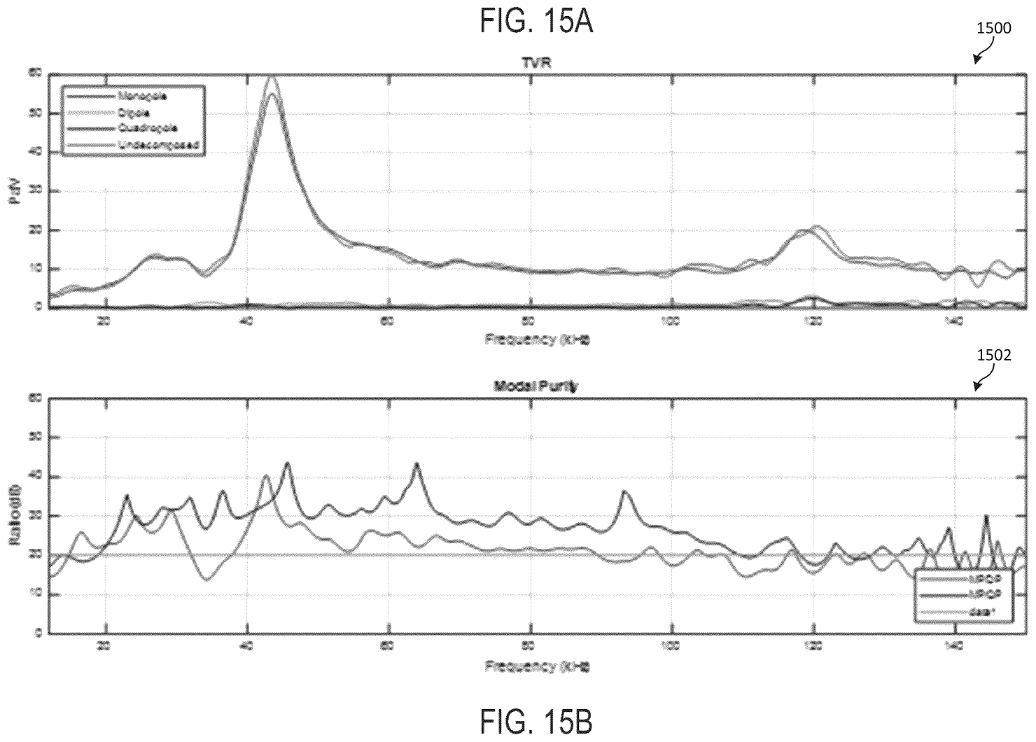

FIGS. 15A and 15B illustrate example graphs 1500, 1502 of an angled transmitter test in a monopole form, in accordance with aspects of the present disclosure. Referring to FIGS. 15A and 15B, a free field water tank test result using a monopole transmitter is shown and illustrates that the TTCE tool 400 can operate within a frequency range between approximately 1 kHz to 150 kHz. The various curves (e.g., monopole curve, dipole curve, quadropole curve, and undecomposed curve) illustrate modal decomposed results, which can indicate modal purity of the monopole as being very good.

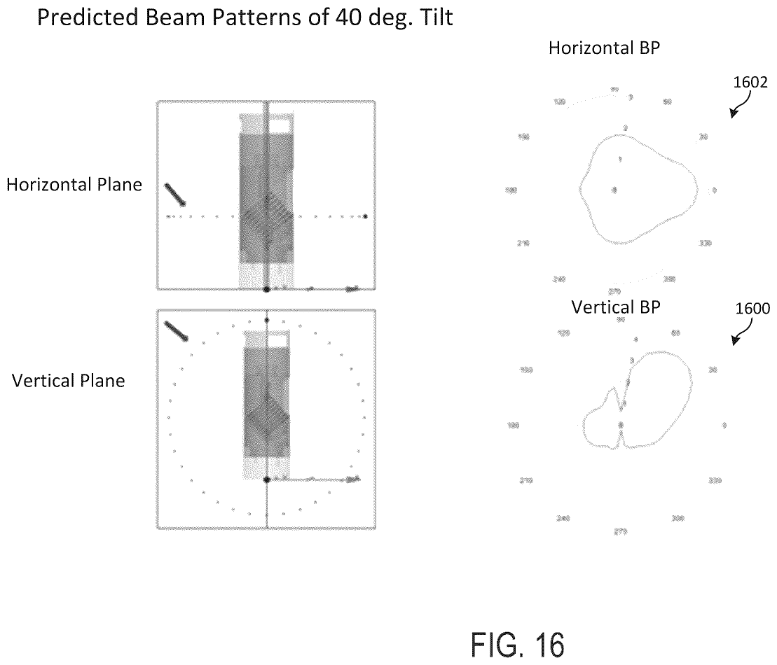

FIG. 16 illustrates example acoustic radiation simulations 1600, 1602 in a vertical plane and a horizontal plane, respectively, in accordance with aspects of the present disclosure. In some implementations, the performance of the angled transmitter 408 with wrap-around acoustic reflectors 1300 can be predicted with an acoustic simulation computer program that can simulate an acoustic output by using a 50 kHz center frequency pulse in a radiating pattern at a vertical plane 1604 and a horizontal plane 1606 that pass the center axis of the transmitter. FIG. 16 illustrates a successful conversion from a monopole transmitter into a directional transmitter.

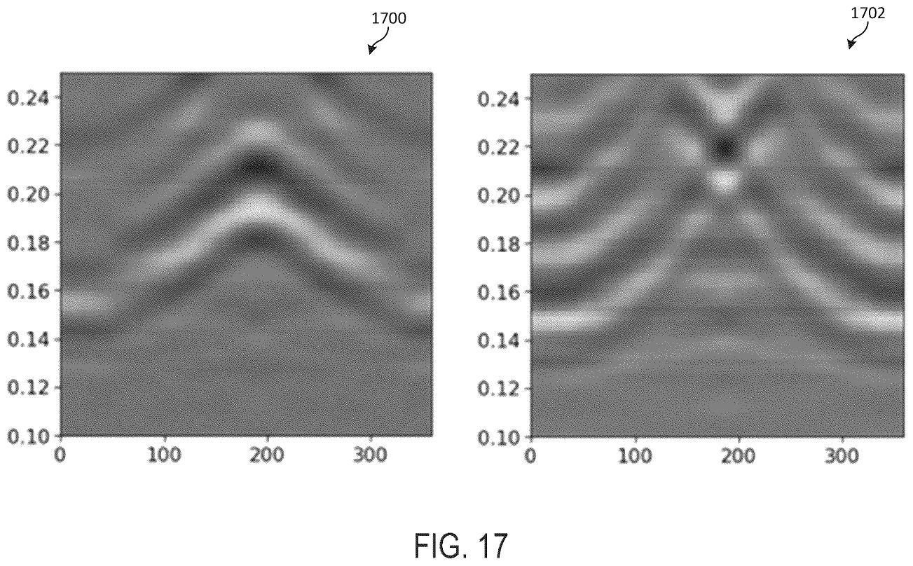

FIG. 17 illustrates example graphs 1700, 1702 of measurements of 360-degrees Casing reflections from inside an eccentered tubing, in accordance with aspects of the present disclosure. For example, FIG. 17 illustrates casing reflections of an angled transmitter inside of a 4-inch tubing surrounded by a 7 ⅝ inch casing that can utilize an ultrasonic frequency pulse, centered at 50 kHz, to map a fluid-casing interface. Referring to FIG. 17, the 360 degrees Casing reflected signals are shown after the tubing multiple reflections are removed. The left graph 1700 of FIG. 17 illustrates 25% eccentered tubing result, while the right graph 1702 of FIG. 17 illustrates 50% eccentered tubing result. Both graphs 1700, 1702 of FIG. 17 indicate that the casing reflections are clearly identifiable.

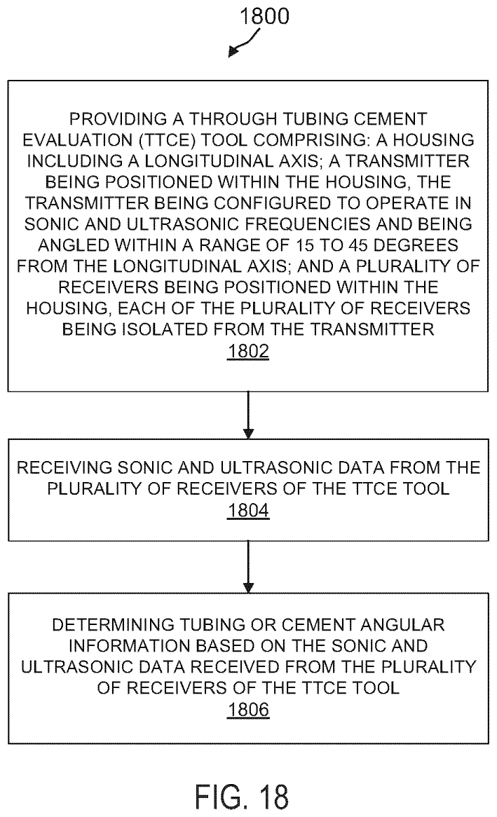

Having disclosed some example system components and concepts, the disclosure now turns to FIG. 18, which illustrates an example method 1800 for providing a TTCE tool 400. The steps outlined herein are exemplary and can be implemented in any combination thereof, including combinations that exclude, add, or modify certain steps.

Referring also to FIG. 4, at step 1802, the method 1800 can include providing a through tubing cement evaluation (TTCE) tool 400 comprising: a housing 402 including a longitudinal axis; a transmitter 408 being positioned within the housing 402, the transmitter 408 being configured to operate in sonic and ultrasonic frequencies and being angled within a range (e.g., 15 to 45 degrees) from the longitudinal axis; and a plurality of receivers 406 being positioned within the housing 402, each of the plurality of receivers 406 being isolated from the transmitter 408.

At step 1804, the method 1800 can include receiving sonic and/or ultrasonic data from the plurality of receivers 406 of the TTCE tool 400.

At step 1806, the method 1800 can include determining tubing or cement angular information based on the sonic and/or ultrasonic data received from the plurality of receivers 406 of the TTCE tool 400.

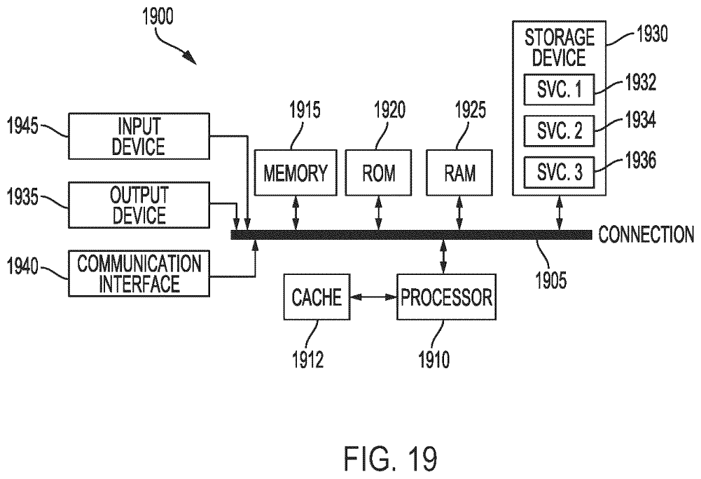

FIG. 19 illustrates an example computing device architecture 1900, which can be employed to perform various steps, methods, and techniques disclosed herein. The various implementations will be apparent to those of ordinary skill in the art when practicing the present technology. Persons of ordinary skill in the art will also readily appreciate that other system implementations or examples are possible.

As noted above, FIG. 19 illustrates an example computing device architecture 1900 of a computing device, which can implement the various technologies and techniques described herein. The components of the computing device architecture 1900 are shown in electrical communication with each other using a connection 1905, such as a bus. The example computing device architecture 1900 includes a processing unit (CPU or processor) 1910 and a computing device connection 1905 that couples various computing device components including the computing device memory 1915, such as read only memory (ROM) 1920 and random-access memory (RAM) 1925, to the processor 1910.

The computing device architecture 1900 can include a cache of high-speed memory connected directly with, in close proximity to, or integrated as part of the processor 1910. The computing device architecture 1900 can copy data from the memory 1915 and/or the storage device 1930 to the cache 1912 for quick access by the processor 1910. In this way, the cache can provide a performance boost that avoids processor 1910 delays while waiting for data. These and other modules can control or be configured to control the processor 1910 to perform various actions. Other computing device memory 1915 may be available for use as well. The memory 1915 can include multiple different types of memory with different performance characteristics. The processor 1910 can include any general-purpose processor and a hardware or software service, such as service 1 1932, service 2 1934, and service 3 1936 stored in storage device 1930, configured to control the processor 1910 as well as a special-purpose processor where software instructions are incorporated into the processor design. The processor 1910 may be a self-contained system, containing multiple cores or processors, a bus, memory controller, cache, etc. A multi-core processor may be symmetric or asymmetric.

To enable user interaction with the computing device architecture 1900, an input device 1945 can represent any number of input mechanisms, such as a microphone for speech, a touch-sensitive screen for gesture or grail input, keyboard, mouse, motion input, speech and so forth. An output device 1935 can also be one or more of a number of output mechanisms known to those of skill in the art, such as a display, projector, television, speaker device, etc. In some instances, multimodal computing devices can enable a user to provide multiple types of input to communicate with the computing device architecture 1900. The communications interface 1940 can generally govern and manage the user input and computing device output. There is no restriction on operating on any particular hardware arrangement and therefore the basic features here may easily be substituted for improved hardware or firmware arrangements as they are developed.

Storage device 1930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1925, read only memory (ROM) 1920, and hybrids thereof. The storage device 1930 can include services 1932, 1934, 1936 for controlling the processor 1910. Other hardware or software modules are contemplated. The storage device 1930 can be connected to the computing device connection 1905. In one aspect, a hardware module that performs a particular function can include the software component stored in a computer-readable medium in connection with the necessary hardware components, such as the processor 1910, connection 1905, output device 1935, and so forth, to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data, which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Statements of the disclosure include:

Statement 1: A through tubing cement evaluation (TTCE) tool comprising: a housing including a longitudinal axis; a transmitter being positioned within the housing, the transmitter being configured to operate in sonic and ultrasonic frequencies and being angled with respect to the longitudinal axis; a plurality of receivers being positioned within the housing, each of the plurality of receivers being isolated from the transmitter; one or more processors to: receive at least one of sonic and ultrasonic data from the plurality of receivers; and determine tubing or cement angular information based on the at least one of the sonic and ultrasonic data received from the plurality of receivers.

Statement 2: The TTCE tool of statement 1, wherein the transmitter is angled with respect to the longitudinal axis within a range of about 15 degrees to about 45 degrees.

Statement 3. The TTCE tool of statements 1-2, wherein the transmitter comprises a unipolar transmitter having a bandwidth between about 1 kHz and 150 kHz.

Statement 4. The TTCE tool of statements 1-3, wherein the transmitter comprises a lead zirconate titanate (PZT) cylinder that is angled with respect to the longitudinal axis.

Statement 5. The TTCE tool of statements 1-4, wherein the transmitter comprises a lead zirconate titanate (PZT) disc that is angled with respect to the longitudinal axis.

Statement 6. The TTCE tool of statements 1-5, further comprising an acoustic reflector that wraps around at least a portion of the transmitter, the acoustic reflector having a high impedance contrast to convert the transmitter from a monopole into a directional transmitter.

Statement 7. The TTCE tool of statements 1-6, wherein the housing comprises an acoustic window that is openable in a predetermined acoustic radiating direction to radiate sonic and ultrasonic frequencies from the transmitter.

Statement 8. The TTCE tool of statements 1-7, wherein at least one receiver of the plurality of receivers is unipolar.

Statement 9. The TTCE tool of statements 1-8, further comprising at least one additional receiver positioned opposite the at least one receiver with respect to the longitudinal axis for performing dipole and monopole resonant mode measurements.

Statement 10. The TTCE tool of statements 1-9, further comprising a plurality of mass blocks, each mass block of the plurality of mass blocks supporting one of the plurality of receivers.

Statement 11. The TTCE tool of statements 1-10, wherein the plurality of receivers includes twenty-three receivers spaced approximately one inch apart.

Statement 12. The TTCE tool of statements 1-11, further comprising at least one acoustic isolator positioned between the transmitter and a first receiver of the plurality of receivers.

Statement 13. The TTCE tool of statements 1-12, wherein the at least one acoustic isolator includes one or more gaps or cavities that are substantially perpendicular to the longitudinal axis.

Statement 14. The TTCE tool of statements 1-13, further comprising a plurality of acoustic isolators, each acoustic isolator isolating a respective one of the plurality of receivers from the transmitter.

Statement 15. The TTCE tool of statements 1-14, wherein the housing is a 3D-printed structure, and wherein each acoustic isolator is formed by the 3D-printed structure of the housing.

Statement 16. The TTCE tool of statements 1-15, wherein a cross-section of at least one of the plurality of acoustic isolators is L-shaped.

Statement 17. The TTCE tool of statements 1-16, further comprising a motor to rotate the TTCE tool around the longitudinal axis to facilitate azimuthal acoustic measurements.

Statement 18. The TTCE tool of statements 1-17, wherein the one or more processors use the transmitter and at least one receiver positioned proximally to the transmitter to measure an ultrasonic pitch catch measurement.

Statement 19. The TTCE tool of statements 1-18, wherein the one or more processors use the transmitter and transmitter and at least one receiver positioned distally to the transmitter to measure a sonic pitch-catch measurement.

Statement 20. A method for performing through tubing cement evaluation (TTCE) comprising: providing a TTCE tool comprising: a housing including a longitudinal axis; a transmitter being positioned within the housing, the transmitter being configured to operate in sonic and ultrasonic frequencies and being angled with respect to the longitudinal axis; a plurality of receivers being positioned within the housing, each of the plurality of receivers being isolated from the transmitter; and using the transmitter and at least a portion of the plurality of receivers to perform one or more of an ultrasonic pitch-catch measurement, a sonic pitch-catch measurement, and a resonant mode measurement.

What is claimed is:

1. A through tubing cement evaluation (TTCE) tool comprising:
a housing including a longitudinal axis;
a transmitter being positioned within the housing, the transmitter being configured to operate in sonic and ultrasonic frequencies and being angled with respect to the longitudinal axis;
a plurality of receivers being positioned within the housing, each of the plurality of receivers being isolated from the transmitter;
one or more processors to:
receive at least one of sonic and ultrasonic data from the plurality of receivers; and
determine tubing or cement angular information based on the at least one of the sonic and ultrasonic data received from the plurality of receivers.

2. The TTCE tool of claim 1, wherein the transmitter is angled with respect to the longitudinal axis within a range of about 15 degrees to about 45 degrees.

3. The TTCE tool of claim 1, wherein the transmitter comprises a unipolar transmitter having a bandwidth between about 1 kHz and 150 kHz.

4. The TTCE tool of claim 1, wherein the transmitter comprises a lead zirconate titanate (PZT) cylinder that is angled with respect to the longitudinal axis.

5. The TTCE tool of claim 1, wherein the transmitter comprises a lead zirconate titanate (PZT) disc that is angled with respect to the longitudinal axis.

6. The TTCE tool of claim 1, further comprising an acoustic reflector that wraps around at least a portion of the transmitter, the acoustic reflector having a high impedance contrast to convert the transmitter from a monopole into a directional transmitter.

7. The TTCE tool of claim 1, wherein the housing comprises an acoustic window that is openable in a predetermined acoustic radiating direction to radiate sonic and ultrasonic frequencies from the transmitter.

8. The TTCE tool of claim 1, wherein at least one receiver of the plurality of receivers is unipolar.

9. The TTCE tool of claim 8, further comprising at least one additional receiver positioned opposite the at least one receiver with respect to the longitudinal axis for performing dipole and monopole resonant mode measurements.

10. The TTCE tool of claim 1, further comprising a plurality of mass blocks, each mass block of the plurality of mass blocks supporting one of the plurality of receivers.

11. The TTCE tool of claim 1, wherein the plurality of receivers includes twenty-three receivers spaced approximately one inch apart.

12. The TTCE tool of claim 1, further comprising at least one acoustic isolator positioned between the transmitter and a first receiver of the plurality of receivers.

13. The TTCE tool of claim 12, wherein the at least one acoustic isolator includes one or more gaps or cavities that are substantially perpendicular to the longitudinal axis.

14. The TTCE tool of claim 1, further comprising a plurality of acoustic isolators, each acoustic isolator isolating a respective one of the plurality of receivers from the transmitter.

15. The TTCE tool of claim 14, wherein the housing is a 3D-printed structure, and wherein each acoustic isolator is formed by the 3D-printed structure of the housing.

16. The TTCE tool of claim 15, wherein a cross-section of at least one of the plurality of acoustic isolators is L-shaped.

17. The TTCE tool of claim 1, further comprising a motor to rotate the TTCE tool around the longitudinal axis to facilitate azimuthal acoustic measurements.

18. The TTCE tool of claim of claim 1, wherein the one or more processors use the transmitter and at least one receiver positioned proximally to the transmitter to measure an ultrasonic pitch catch measurement.

19. The TTCE tool of claim 1, wherein the one or more processors use the transmitter and transmitter and at least one receiver positioned distally to the transmitter to measure a sonic pitch-catch measurement.

20. A method for performing through tubing cement evaluation (TTCE) comprising:
providing a TTCE tool comprising:
a housing including a longitudinal axis;
a transmitter being positioned within the housing, the transmitter being configured to operate in sonic and ultrasonic frequencies and being angled with respect to the longitudinal axis;
a plurality of receivers being positioned within the housing, each of the plurality of receivers being isolated from the transmitter; and
using the transmitter and at least a portion of the plurality of receivers to perform one or more of an ultrasonic pitch-catch measurement, a sonic pitch-catch measurement, and a resonant mode measurement.
